(19) United States
(12) Patent Application Publication
(10) Pub. No.: US 2011/0143195 A1
(43) Pub. Date: Jun. 16, 2011

(54) NEGATIVE ELECTRODE FOR LITHIUM ION BATTERY, METHOD FOR PRODUCING THE SAME, AND LITHIUM ION BATTERY

(76) Inventors: Shuji Ito, Nara (JP); Tatsuki Hiraoka, Osaka (JP); katsumi Kashiwagi, Nara (JP); Hideharu Takezawa, Nara (JP); Masaya Ugaji, Osaka (JP); Kunihiko Mineya, Osaka (JP)

(21) Appl. No.: 13/059,344

(22) PCT Filed: Jun. 17, 2010
(86) PCT No.: PCT/JP2010/004025

§ 371 Date: Feb. 16, 2011

(30) Foreign Application Priority Data
Jun. 29, 2009 (JP) 2009-153515

(51) Int. Cl. H01M 4/58; H01M 4/26; H01M 10/056

(52) U.S. Cl. 429/199; 429/218.1; 429/231.95; 29/623.5

(57) ABSTRACT

A negative electrode 10 for a lithium ion battery of the present invention includes a negative electrode current collector 11, protrusions 13 formed so as to be spaced apart from each other on a surface of the negative electrode current collector 11, columns 12 supported on the protrusions 13 one by one, and a coating layer 15 coating a surface of each of the columns 12. The columns 12 include a negative electrode active material including either one of silicon and tin, and further include lithium absorbed thereinto. The coating layer 15 contains at least one of lithium carbonate and lithium fluoride and is formed by exposing the columns 12 to an atmosphere with a dew point temperature of −60° C. or higher and 0° C. or lower.

### TECHNICAL FIELD

The present invention relates to lithium ion batteries, and specifically relates to an improvement of a negative electrode including an alloy-formable active material in lithium ion batteries.

### BACKGROUND ART

In recent years, an alloy-formable active material that absorbs and desorbs lithium ions by alloying with lithium has been attracting attention as a negative electrode active material used for lithium ion batteries. For example, silicon, silicon-containing alloys, silicon compounds, tin, tin-containing alloys, and tin compounds are known as such alloy-formable active material.

However, the alloy-formable active material tends to expand greatly when absorbing lithium ions. When the alloy-formable active material expands, some of the alloy-formable active material particles may crack or separate from the negative electrode current collector, or the negative electrode current collector may be deformed. If some of the alloy-formable active material particles crack and new surfaces appear, the formation of an electrically insulating coating film is accelerated by the reaction between the alloy-formable active material and the non-aqueous electrolyte. The insulating coating film reduces the electron conductivity between the alloy-formable active material and the negative electrode current collector, causing the internal impedance in the battery to increase. Further, the insulating coating film prevents the intercalation and deintercalation of lithium ions into and from the alloy-formable active material, causing the charge/discharge cycle performance of the battery to deteriorate.

### CITATION LIST

### Patent Literature

[PTL 1] Japanese Laid-Open Patent Publication No. 2004-127561
[PTL 2] Japanese Laid-Open Patent Publication No. 2005-166469
[PTL 3] Japanese Laid-Open Patent Publication No. 2005-216601
[PTL 4] Japanese Laid-Open Patent Publication No. 2007-257867

### SUMMARY OF INVENTION

### Technical Problem

Patent Literature 1 discloses an electrode for a lithium secondary battery, in which columns of alloy-formable active material are arranged in a regular pattern so as to be spaced apart from each other on the current collector. By forming the alloy-formable active material in such a manner, the stress generated by expansion of the alloy-formable active material can be reduced in the direction along the surface of the current collector. However, reaction between the alloy-formable active material and the non-aqueous electrolyte cannot be inhibited by the configuration disclosed in this document.

Patent Literatures 2 and 3 disclose a negative electrode, in which a negative electrode active material layer made of an alloy-formable active material is provided with a lithium carbonate coating film for inhibiting reaction between the negative electrode active material and the non-aqueous electrolyte. With regard to the method of forming the coating film, Patent Literature 2 discloses sputtering, vapor deposition, and chemical vapor phase deposition. Patent Literature 3 discloses that an alloy-formable active material with metallic lithium deposited on the surface thereof beforehand by vacuum vapor deposition is brought into contact with an inert gas containing carbon dioxide in a vacuum chamber, thereby to form a lithium carbonate coating film on the surface of the alloy-formable active material. However, the negative electrode active material layers in Patent Literatures 2 and 3 are formed as an almost homogeneous film on the surface of the negative electrode current collector, and have no space therein for reducing the stress generated by expansion of the alloy-formable active material. As such, when the alloy-formable active material expands, cracks may occur in the negative electrode active material layer and the lithium carbonate coating film, failing to inhibit reaction between the alloy-formable active material and the non-aqueous electrolyte.

Patent Literature 4 discloses a negative electrode, in which a negative electrode active material layer is formed by co-vapor deposition of silicon and lithium fluoride. In the negative electrode active material layer thus formed, the expansion of silicon due to absorption of lithium is suppressed. Further, if cracks occur in the negative electrode active material layer when silicon expands, lithium fluoride in the negative electrode active material layer forms a film that coats the newly-created surfaces on the negative electrode active material layer, which inhibits reaction between silicon and the non-aqueous electrolyte. However, in the negative electrode disclosed in this document, due to the presence of lithium fluoride in the negative electrode active material layer, the amount of silicon contained in the negative electrode active material is decreased, and thus the capacity is reduced.

The present invention intends to prevent deformation of the negative electrode and inhibit reaction between the negative electrode and the non-aqueous electrolyte, and improve the charge/discharge performance in a lithium ion battery using an alloy-formable active material as a negative electrode active material.

### Solution to Problem

The present inventors have conducted detailed analysis on the shape of an alloy-formable active material. As a result, the inventors have found that in order to reduce the stress generated by expansion of the alloy-formable active material, it is preferable to form the alloy-formable active material into columns and arrange the columns in a regular pattern so as to be spaced apart from each other on the current collector.

Further, the present inventors have conducted detailed analysis on the method of forming, on the surfaces of the columns, a coating film for inhibiting reaction between the alloy-formable active material and the non-aqueous electrolyte. As a result, the inventors have obtained the following finding. When sputtering, vapor deposition, and chemical vapor phase deposition are employed to form a film of lithium carbonate or lithium fluoride on the columns of alloy-formable active material arranged as described above, most of the vapor of lithium carbonate or lithium fluoride moves straight, although depending on the degree of vacuum in film formation. As such, the vapor is deposited preferentially on portions of the surfaces of the columns facing the generation source of the vapor, and only a small part of the vapor in the form of scattered particles is deposited on the side surfaces of the columns. Therefore, when the above methods are employed, some portions of the surfaces of the columns are left uncoated with a coating layer of lithium carbonate or lithium fluoride, or, if coated, the thickness of the coating layer is not uniform. Further, when the columns placed in a vacuum chamber are brought into contact with an inert gas containing carbon dioxide, the metallic lithium included beforehand in the columns directly reacts with carbon dioxide, to produce lithium carbonate. However, in this method, it is difficult to evenly form a lithium carbonate layer on the entire surfaces of the columns.

Based on the above finding, the inventors have conceived that it could be possible to form a lithium carbonate coating layer evenly on the entire surfaces of the columns, by allowing the columns into which lithium has been absorbed beforehand to be exposed to a predetermined atmosphere. And then, the inventors have found completely new facts: (1) a lithium carbonate coating layer having an almost uniform thickness can be evenly formed on the entire surfaces of the columns by allowing the columns to be exposed to an atmospheric environment containing some degree of moisture, instead of storing the columns in an atmosphere with an extremely low dew point temperature, which is usually set as a condition when an alloy-formable active material is handled; and (2) after a lithium carbonate coating film has formed, at least part of the lithium carbonate coating film can be converted into lithium fluoride by allowing it to contact with a non-aqueous electrolyte including a fluorine-containing compound. And finally, the inventors have arrived at the present invention.

A negative electrode for a lithium ion battery according to one aspect of the present invention includes a negative electrode current collector, a plurality of columns formed so as to be spaced apart from each other on a surface of the negative electrode current collector, and a coating layer coating an entire surface of each of the plurality of columns, wherein: the columns include a negative electrode active material including either one of silicon and tin, and further include lithium absorbed thereinto; and the coating layer contains at least one of lithium carbonate and lithium fluoride.

A method for producing a negative electrode for a lithium ion battery according to another aspect of the present invention includes the steps of: forming a plurality of columns so as to be spaced apart from each other on a surface of a negative electrode current collector, the columns including a negative electrode active material including either one of silicon and tin; allowing lithium to be absorbed into the plurality of columns; and allowing the columns with lithium absorbed thereinto to be exposed to an atmosphere with a dew point temperature of −60° C. or higher and 0° C. or lower, thereby to form a coating layer containing lithium carbonate on surfaces of the columns.

A lithium ion battery according to yet another aspect of the present invention includes: a negative electrode including a negative electrode current collector, a plurality of columns formed so as to be spaced apart from each other on a surface of the negative electrode current collector, and a coating layer coating a surface of each of the plurality of columns; a positive electrode including a positive electrode active material capable of absorbing and desorbing lithium; a separator insulating the negative electrode and the positive electrode from each other; and a non-aqueous electrolyte, wherein: the columns include a negative electrode active material including either one of silicon and tin, and further include lithium absorbed thereinto; and the coating layer contains at least one of lithium carbonate and lithium fluoride.

### Advantageous Effects of Invention

According to the present invention, it is possible to obtain a negative electrode for a lithium ion battery having a high capacity and being capable of preventing deformation of the negative electrode and inhibiting reaction between the negative electrode and the non-aqueous electrolyte. Further, by using this negative electrode, it is possible to obtain a highly reliable lithium ion battery having a high capacity and being excellent in cycle performance.

### BRIEF DESCRIPTION OF DRAWINGS

FIG. 1 is a longitudinal cross-sectional view showing an embodiment of a negative electrode.

FIG. 2 is a schematic plan view showing an embodiment of a negative electrode current collector.

FIG. 3 is a longitudinal cross-sectional view showing an embodiment of a column.

FIG. 4 is a schematic front view showing one example of a vapor deposition apparatus for forming columns.

FIG. 5 is a schematic longitudinal cross-sectional view showing an embodiment of a lithium ion battery.

FIG. 6 is an X-ray photoelectron spectroscopy spectra (C1s spectra) measured on the columns having been stored for 1 day in an atmosphere with a dew point temperature of −30° C.

FIG. 7 is an X-ray photoelectron spectroscopy spectra (C1s spectra) measured on the columns having been stored for 1 day in an atmosphere with a dew point temperature of −60° C. or lower.

### DESCRIPTION OF EMBODIMENTS

The objects, features and advantages of the present invention would be more readily apparent from the following detailed description and appended drawings.

First, a preferred embodiment of the negative electrode for a lithium ion battery is described in detail with reference to the drawings.

Referring to FIG. 1, a negative electrode 10 for a lithium ion battery includes a negative electrode current collector 11, a plurality of columns 12 formed so as to protrude from the surface of the negative electrode current collector 11, and a coating layer 15 coating the surface of each of the plurality of columns 12. The negative electrode current collector 11 has a plurality of protrusions 13 on the surface thereof, and the protrusions 13 support the columns 12 one by one. It should be noted that there are another plurality of columns 12 and protrusions 13 behind the columns 12 and the protrusions 13 illustrated in FIG. 1, but the illustrations of these are omitted in FIG. 1.

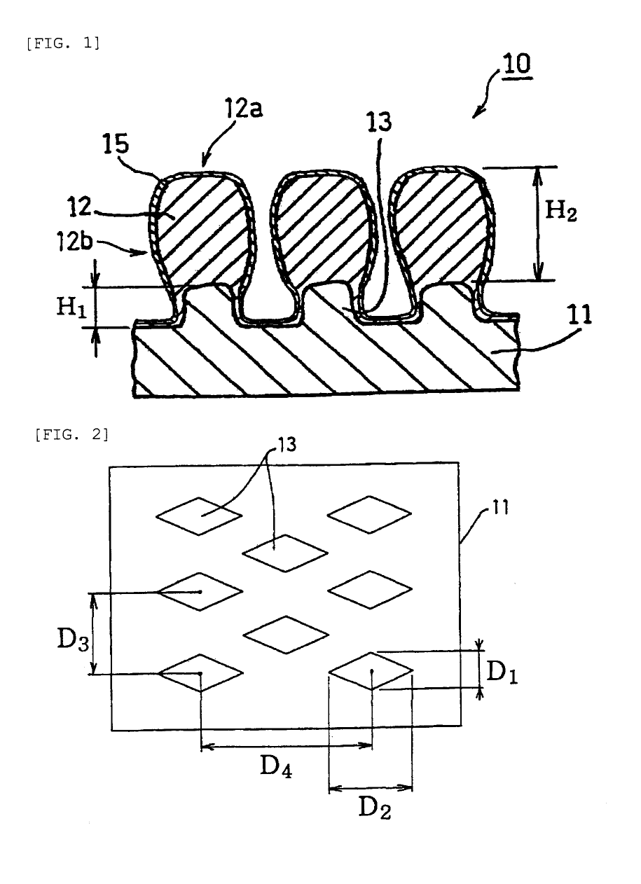

Referring to FIG. 2, the protrusions 13 are formed so as to be spaced apart from each other on the surface of the negative electrode current collector 11. As such, referring again to FIG. 1, the columns 12 supported on the protrusions 13 are also spaced apart from each other, providing a space between the columns 12 adjacent to each other. If the columns 12 expand when the negative electrode active material absorbs lithium, this space functions to prevent the columns 12 from colliding with each other or reduce the impact of the collision of the columns 12. For this reason, by forming the protrusions 13 so as to be spaced apart from each other, and thus forming the columns 12 so as to be spaced apart from each other, it is possible, when the columns 12 expand, to prevent the columns 12 themselves from being subjected to excessive stress. The protrusions 13 are preferably arranged in a regular pattern on the surface of the negative electrode current collector 11. By arranging the protrusions 13 in a regular pattern, the space between the columns 12 can be easily and reliably formed.

Examples of the negative electrode current collector 11 include rolled copper foil and electrolytic copper foil. Among these, electrolytic copper foil is preferred because of its large surface roughness, in view of improving the adhesion strength of the negative electrode active material. The copper foil is made of copper or a copper alloy. Copper and copper alloys are suitable materials for a negative electrode current collector plate because they are excellent in electrical conductivity and are not alloyable with lithium. The tensile strength of the copper foil is preferably 6 N/mm or more, more preferably 8 N/mm or more, and further more preferably 10 N/mm or more. If the mechanical strength of the copper foil is insufficient, there is a possibility that creases occur on the negative electrode plate, when the columns 12 are expanded or contracted by absorption or desorption of lithium into or from the negative electrode active material. The thickness of the negative electrode current collector 11 excluding the protrusions 13 is preferably 1 to 50 μm, more preferably 6 to 40 μm, and particularly preferably 8 to 33 μm.

The surface roughness Rz of the negative electrode current collector 11 measured on at least the protrusions 13 is preferably 0.1 to 30 μm, and more preferably 0.5 to 15 μm. When the surface roughness Rz on the protrusions 13 is below 0.1 μm, there is a possibility that the adhesion strength of the negative electrode active material is reduced. The negative electrode current collector 11 with rough surface having a surface roughness Rz exceeding 30 μm means that the negative electrode current collector 11 itself has a large thickness. The negative electrode current collector 11 having a large thickness is unfavorable for achieving a high energy density of the battery. The surface roughness Rz is a “maximum height Rz” specified in the Japanese Industrial Standard (JIS) B 0601₋₂₀₀₁ and can be measured by using, for example, a surface roughness meter.

When the negative electrode current collector 11 is a copper foil, it is preferable to roughen the surface thereof and apply electrolytic plating to the roughened surface in order to improve the adhesion strength of the negative electrode active material. The copper foil may be a surface-roughened copper foil commercially available for use as a printed circuit board.

Referring to FIG. 2, each of the protrusions 13 is formed such that the plane shape thereof is rhombus when viewed from the top. The plane shape of the protrusion 13 is not limited thereto, and may be, for example, a polygon such as a regular square, a rectangle and a pentagon, or a circle, or an ellipse. The length (diameter) of the protrusion 13 along the surface of the negative electrode current collector 11 is preferably 2 to 200 μm, and more preferably 10 to 50 μm. The height H₁ of the protrusion 13 measured as a height from the surface of the negative electrode current collector 11 excluding the protrusions 13 in the direction normal to the negative electrode current collector 11 is preferably 2 to 15 μm, and more preferably 6 to 12 μm. The distance between the protrusions 13 adjacent to each other measured as a center-to-center distance between the adjacent protrusions 13 is preferably 10 to 100 μm, more preferably 20 to 80 μm, and particularly preferably 20 to 60 μm. In FIG. 2, the protrusions 13 are arranged in a staggered pattern. The pattern of arranging the protrusions 13 is not limited thereto, and may be other patterns such as a checker pattern.

The columns 12 can be formed by depositing a negative electrode active material on the protrusions 13 of the negative electrode current collector 11 by a dry film-forming method such as vacuum vapor deposition, sputtering, and chemical vapor deposition.

As the negative electrode active material, a negative electrode active material including either one of silicon and tin is used, in view of producing a high capacity negative electrode. In particular, a negative electrode active material including silicon is preferred.

The negative electrode active material including silicon is, for example, a silicon simple substance, a silicon alloy, a compound containing silicon and oxygen, a compound containing silicon and nitrogen, or a compound containing silicon, oxygen and nitrogen. The compound containing silicon and oxygen is preferably a silicon oxide, and more preferably a silicon oxide represented by the general formula: SiOₓ, where 0<x<2. The value of x representing the content of oxygen element is more preferably 0.01≦x≦1. The silicon oxide may contain another element such as Fe, Al, Ca, Mn and Ti. Alternatively, two or more silicon oxides having different silicon-to-oxygen ratios may be used in combination as the negative electrode active material.

The crystal state of the negative electrode active material may be any one of polycrystalline, single-crystalline, microcrystalline and amorphous. A polycrystal is composed of a plurality of crystallites. A microcrystal has a crystallite size of 50 nm or less. The crystal state of the negative electrode active material can be analyzed by, for example, X-ray diffraction (XRD) or transmission electron microscope (TEM). The size of crystallites is calculated using the Scherrer's formula from the half width of the highest peak of intensity observed within the range of 2θ=15 to 40° in a diffraction pattern obtained by XRD measurement on the negative electrode active material. When no sharp peak is observed within the range of 2θ=15 to 40° in the diffraction pattern, and only a broad halo pattern is observed, the negative electrode active material is regarded as substantially amorphous.

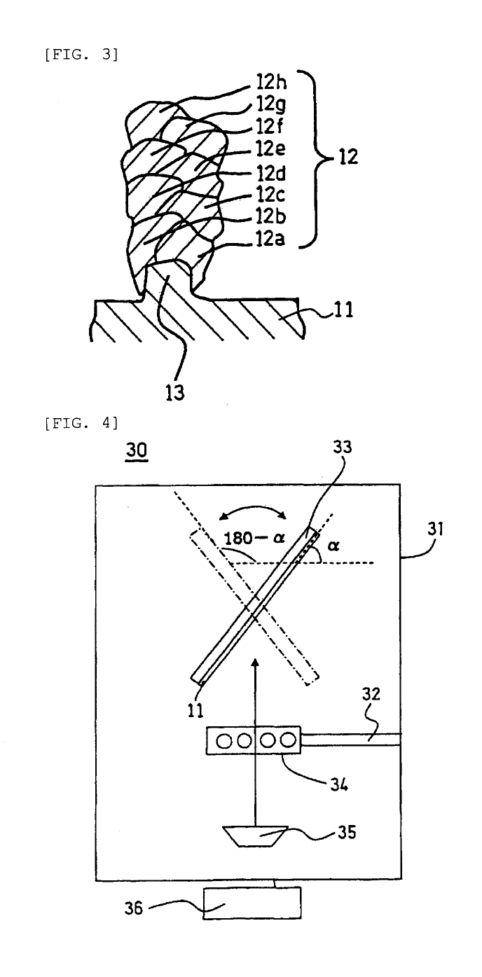

Referring to FIG. 3 showing an embodiment of a column, the column 12 may be formed, for example, as a stack of a plurality of grain layers 12a, 12b, . . . 12g. When the column 12 is formed as a stack of a plurality of grain layers 12a, 12b, . . . 12g, the stress generated when the negative electrode active material expands by absorbing lithium can be dispersed at the interfaces between grain layers 12a, 12b, . . . 12g.

The column 12 can be formed as a stack of a plurality of grain layers 12a, 12b, . . . 12g as shown in FIG. 3, by using, for example, a vapor deposition apparatus 30 as shown in FIG. 4. The vapor deposition apparatus 30 includes a chamber 31 which is a pressure-resistant container. The chamber 31 includes in its interior a pipe 32 and a nozzle 34 for supplying gas such as oxygen and nitrogen into the chamber 31, a support table 33 for placing the negative electrode current collector 11 thereon, and a target 35 for accommodating an alloy-formable active material (or a raw material thereof) serving as the negative electrode active material. A power source 36 provided outside of the chamber 31 is electrically connected to an electron beam generator, to apply voltage for generating electron beams to an electron beam generator. The atmosphere in the chamber 31 can be adjusted by connecting a second pipe (not shown) to the chamber 31 and introducing gas, as needed, from the second pipe. A vapor deposition apparatus having the same configuration as that of the vapor deposition apparatus 30 is commercially available from, for example, Ulvac Inc.

The support table 33 is a rotatably supported plate-like member. The negative electrode current collector 11 is placed on one surface of the support table 33. The support table 33 is rotatable around the rotation axis extending in the direction perpendicular to the sheet of drawing, and can be freely set at any position, for example, a position indicated by the solid line or by the dot-dash line in FIG. 4. When the support table 33 is in the position indicated by the solid line in FIG. 4, a surface of the support table 33 on which the negative electrode current collector 11 is to be placed faces the target 35 disposed vertically below the support table 33, forming an angle α° between the surface of the support table 33 and a direction horizontal to the chamber 31. When the support table 33 is in the position indicated by the dot-dash line in FIG. 4, a surface of the support table 33 on which the negative electrode current collector 11 is to be placed faces the target 35 disposed vertically below the support table 33, forming an angle (180−α)° between the surface of the support table 33 and a direction horizontal to the chamber 31. The angle α° may be selected, as needed, according to the size of the columns 12 to be formed, the growth direction of the columns 12, and other requirements.

The alloy-formable active material or the raw material thereof accommodated in the target 35 is heated when irradiated with electron beams, and is vaporized. The vapor thus generated is mixed with gas supplied from the nozzle 34, and supplied to the surface of the negative electrode current collector 11.

Referring to FIGS. 3 and 4, when the support table 33 is set beforehand at the position indicated by the solid line in FIG. 4, and the target 35 is irradiated with electron beams, a mixture of the vapor generated from the target 35 and the gas supplied from the nozzle 34 is supplied onto the protrusions 13 in the direction inclined from the direction normal to the negative electrode current collector 11. As a result, the first grain layer 12a of alloy-formable active material is formed on the surfaces of the protrusions 13. At the point in time when the grain layer 12a has grown to a predetermined size, the position of the support table 33 is changed to that indicated by the dot-dash line in FIG. 4. Under the same conditions except this, the vapor of alloy-formable active material is supplied onto the protrusions 13, to form the second grain layer 12b of alloy-formable active material on the surfaces of the protrusions 13. Subsequently, the position of the support table 33 is changed alternately, to repeat the above vapor deposition six times. In this manner, the columns 12 each formed of a stack of eight grain layers in total (12a to 12h) can be formed.

Referring again to FIG. 1, the height H₂ of the column 12 is set, without any limitation, according to the capacity of a lithium ion battery and other requirements, but is preferably about 3 to 40 μm, more preferably 5 to 30 μm, and particularly preferably 8 to 25 μm. When the height H₂ of the column 12 is below 3 μm, the volume ratio of the negative electrode active material in the negative electrode 10 as a whole is reduced, and thus a battery with sufficient energy density may not be obtained. When the height H₂ of the column 12 exceeds 40 μm, the stress generated in association with expansion of the negative electrode active material during charging is increased at the interfaces between the negative electrode current collector 11 and the columns 12, and thus, for example, deformation of the negative electrode current collector 11 may occur. The height H₂ of the column 12 is defined as a distance measured from a top surface of the protrusion 13 of the negative electrode current collector 11 to a top surface 12a of the column 12 in the direction normal to the negative electrode current collector 11.

The coating layer 15 is a layer coating the surface of each of the columns 12, and contains at least one of lithium carbonate and lithium fluoride. The coating layer 15 is evenly formed on the entire surface of the column 12 extending from its top surface 12a to its side surface 12b. The thickness of the coating layer 15 is preferably 4 nm or more, more preferably 4 to 30 nm, and particularly preferably 6 to 20 nm, on the entire surface of the column 12. By forming the coating layer 15 so as to have a thickness of 4 nm or more on the entire surfaces of the columns 12, it is possible to sufficiently inhibit reaction between the negative electrode active material and the non-aqueous electrolyte. Further, when the thickness of the coating layer 15 is 4 nm or more, even if cracks occur in the coating layer 15 in association with expansion of the columns 12, the appearance of newly-created surfaces is minimized. Furthermore, when the thickness of the coating layer 15 is 4 nm or more, even if cracks occur in the coating layer 15 to cause newly-created surfaces to appear on the surfaces of the columns 12, the newly-created surfaces are selectively coated because a sufficient amount lithium carbonate is present in the coating layer 15 around the cracks, which reacts with a fluorine-containing compound and the like included in the non-aqueous electrolyte and is converted into lithium fluoride. As such, the reaction between the negative electrode active material and the non-aqueous electrolyte can be more reliably inhibited. With regard to the thickness of the coating layer 15, the difference between a thickness of the coating layer 15 at the top surface 12a of the column 12 and a thickness of the coating layer 15 at the side surface 12b of the column 12 is preferably 3 nm or less, and more preferably 2 nm or less.

The coating layer 15 can be formed by the steps of: allowing lithium to be absorbed into the columns 12 of negative electrode active material; and exposing the columns with lithium absorbed thereinto to an atmosphere with a dew point temperature of −60° C. or higher and 0° C. or lower.

Lithium is allowed to be absorbed into the columns 12 by the method of, for example: (i) depositing metallic lithium on the columns 12 by a vapor phase method; or (ii) electrochemically intercalating lithium into the columns 12.

In depositing metallic lithium on the columns 12 by a vapor phase method, for example, a vapor deposition apparatus similar to that used in forming the columns 12 may be used. Specifically, metallic lithium is deposited on the columns 12 by accommodating lithium in the target 35 in the vapor deposition apparatus 30 as shown in FIG. 4 and performing vapor deposition. The metallic lithium deposited on the surfaces of the columns 12 is absorbed over time into the negative electrode active material forming the columns 12. By vapor depositing lithium with the position of the support table 33 being changed, as needed, alternately between the positions indicated by the solid line and the dash-dot line in FIG. 4, in the vapor deposition apparatus 30 as shown in FIG. 4, lithium can be evenly deposited on the surfaces of the columns 12. Further, in depositing lithium in such a manner, since the incident direction of lithium is inclined with respect to the direction normal to the negative electrode current collector 11, the shadowing effect by the columns 12 works to prevent lithium from adhering onto the surface of the negative electrode current collector 11 (the portion excluding the protrusions 13).

In electrochemically intercalating lithium into the columns 12, for example, the above negative electrode and a metallic lithium plate are immersed in a solution with lithium ion conductivity such that the columns 12 on the negative electrode and the metallic lithium serving as the counter electrode face each other, and then voltage is applied across the negative electrode and the metallic lithium, to allow lithium ions to move from the metallic lithium to the negative electrode.

The amount of lithium to be absorbed into the columns 12 is preferably set according to the irreversible capacity of the negative electrode active material. The irreversible capacity is calculated by subtracting from a charge capacity at the first charge, a discharge capacity at the first discharge after the charge.

By exposing the columns 12 into which lithium has been absorbed in the manner as described above to an atmosphere with a dew point temperature set in the above-mentioned range, the lithium on the surfaces of the columns 12 reacts with the moisture in the atmosphere to produce lithium hydroxide, which further reacts with the carbon dioxide in the atmosphere to produce lithium carbonate. In a fabricated battery, at least part of the lithium carbonate formed on the surfaces of the columns 12 is transformed into lithium fluoride by reaction with the fluorine compound in the non-aqueous electrolyte. As such, the coating layer 15 formed on the surfaces of the columns 12 contains lithium fluoride in addition to lithium carbonate.

As described above, the coating layer 15 is formed by the reaction of the lithium included in the columns 12 with the moisture and carbon dioxide in the atmosphere. The reaction of the lithium with the moisture and carbon dioxide occurs on the entire surfaces of the columns 12 which contact with atmosphere. For this reason, even if the shape of the column 12 is complicated, the coating layer 15 can be evenly formed on the surface thereof by forming the coating layer 15 in the manner as described above.

In addition, as described above, the columns 12 are formed on the surface of the negative electrode current collector 11 so as to be spaced apart from each other, and there is space between the columns 12 adjacent to each other. For this reason, if the negative electrode active material expands as it absorbs lithium, the columns 12 are prevented from being subjected to excessive stress. As such, cracks hardly occur in the coating layer 15 formed on the surfaces of the columns 12, even when the negative electrode active material expands as it absorbs lithium. Further, although the negative electrode active material is formed into a complicated shape, namely, into columns, the coating layer 15 is evenly formed on the surfaces of the columns 12.

Therefore, by forming the coating layer 15 in the manner as described above, it is possible to prevent the deformation of the negative electrode and inhibit reaction between the negative electrode and the non-aqueous electrolyte in a lithium ion battery using an alloy-formable active material as the negative electrode active material.

The exposure time for exposing the columns 12 with lithium absorbed thereinto to an atmosphere with a dew point temperature of −60° C. or higher and 0° C. or lower is preferably 0.5 to 148 hours. The dew point temperature of the atmosphere to which the columns 12 are exposed is particularly preferably −40° C. or higher and −20° C. or lower, and at this time, the exposure time for exposing the columns 12 is preferably 48 to 72 hours.

When the dew point temperature of the atmosphere to which the columns 12 are exposed is below −60° C., the amount of moisture contained in the atmosphere is too small, and the efficiency for producing lithium carbonate is reduced. This may result in failure of formation of a sufficient amount of the coating layer 15 on the surfaces of the columns 12. On the other hand, when the dew point temperature of the atmosphere to which the columns 12 are exposed exceeds 0° C., there is a possibility that lithium carbonate is formed excessively on the surfaces of the columns. When this happens, the internal resistance of the battery is increased.

When the exposure time for exposing the columns 12 to atmosphere is too short, there is a possibility that a sufficient amount of lithium carbonate is not formed on the surfaces of the columns 12. On the other hand, when the exposure time for exposing the columns 12 to atmosphere is too long, there is a possibility that lithium carbonate is formed excessively on the surfaces of the columns 12.

The composition of the atmosphere to which the columns 12 with lithium absorbed thereinto is not particularly limited. The concentration of carbon dioxide in the atmosphere may be adjusted as needed so that the efficiency of reaction between lithium hydroxide and carbon dioxide is increased.

Lithium fluoride coating the columns 12 is formed by the reaction of the lithium carbonate coating the columns 12 with the fluorine compound and the like included in the non-aqueous electrolyte. In order to increase the efficiency of forming lithium fluoride, for example, the columns 12 with lithium carbonate formed on the surfaces thereof may be immersed in a solution containing a solute of a fluorine-containing compound or a non-aqueous solvent of a fluorine-containing compound. Alternatively, the lithium fluoride coating the columns 12 may be formed in the manner described below. First, the negative electrode including the columns 12 with a lithium carbonate layer formed on the surfaces thereof and metallic lithium serving as the counter electrode are positioned such that the columns 12 and the metallic lithium face each other. Subsequently, the above negative electrode and the counter electrode are immersed in a non-aqueous electrolyte including a fluorine-containing compound as at least either the solute or the non-aqueous solvent, and then voltage is applied across the negative electrode and the metallic lithium, to allow lithium ions to move from the metallic lithium to the negative electrode.

Examples of the solute of a fluorine-containing compound include LiPF₆, LiBF₄, LiSbF₆, LiAsF₆, LiCF₃SO₃, and LiCF₃CO₂, among which LiPF₆ is preferred. Examples of the non-aqueous solvent of a fluorine-containing compound include fluorinated carbonates. Examples of fluorinated carbonates include fluoroethylene carbonate, difluoroethylene carbonate, bis(fluoromethyl)carbonate, fluoromethyl methyl carbonate, and fluoromethyl ethyl carbonate, among which fluoroethylene carbonate and difluoroethylene carbonate are preferred.

Next, an embodiment of the lithium ion battery is described.

Referring to FIG. 5, a lithium ion battery 90 includes a housing case 94, and a stacked electrode group and a non-aqueous electrolyte accommodated in the housing case 94. The electrode group includes a negative electrode 10, a positive electrode 91, and a separator 93 interposed between the negative electrode 10 and the positive electrode 91.

The negative electrode 10 may be, for example, the negative electrode as described in the above embodiment. The negative electrode 10 includes a negative electrode current collector 11 and a plurality of columns 12 being formed on the surfaces of the negative electrode current collector 11 and being a negative electrode active material layer. One end of a negative electrode lead 96 is connected to the negative electrode current collector 11. The positive electrode 91 includes a positive electrode current collector 91a, and a positive electrode active material layer 91b formed on the surface of the positive electrode current collector 91a. One end of a positive electrode lead 95 is connected to the positive electrode current collector 91a.

The housing case 94 has a pair of openings at positions opposite to each other. The other end of the positive electrode lead 95 is extended outside through one opening; and the other end of the negative electrode lead 96 is extended outside through the other opening. Each of the openings of the housing case 94 is sealed by using a resin material 97.

Components in the lithium ion battery 90 other than the negative electrode 10 are not particularly limited.

The positive electrode active material may be any material known in the art. Examples of such material include lithium-containing transition metal oxides such as lithium cobalt oxide, lithium nickel oxide, and lithium manganese oxide. The positive electrode active material layer may be formed of the positive electrode active material only or of a material mixture including the positive electrode active material, a binder and a conductive agent. Similarly to the negative electrode active material layer, the positive electrode active material layer may be formed of a plurality of columns. Various materials used as a positive electrode current collector, such as aluminum, an aluminum alloy, nickel, and titanium, may be used as the positive electrode current collector.

The non-aqueous electrolyte may be any electrolyte with lithium ion conductivity conventionally used in lithium ion batteries. The non-aqueous electrolyte includes, for example, a non-aqueous solvent, and a solute dissolved in the non-aqueous solvent.

Examples of the non-aqueous solvent include cyclic carbonic acid esters such as propylene carbonate and ethylene carbonate; chain carbonic acid esters such as diethyl carbonate, ethyl methyl carbonate, and dimethyl carbonate; and cyclic carboxylic acid esters such as γ-butyrolactone. These non-aqueous solvents may be used singly or in combination of two or more.

Examples of the solute to be dissolved in the non-aqueous solvent include those listed as the solute of a fluorine-containing compound. In addition to these, LiClO₄, LiAlCl₄, LiSCN, lithium lower aliphatic carboxylate, LiCl, LiBr, LiI, chloroborane lithium, borates such as lithium bis(1,2-benzenediolato(2-)-O,O′)borate, and imides such as lithium bis(trifluoromethanesulfonyl)imide are included in the examples. These solutes may be used singly or in combination of two or more.

Various forms of materials conventionally used in lithium ion batteries may be used as the materials of the separator and the battery case. In place of the separator, a solid electrolyte with lithium ion conductivity may be used, or alternatively, a gel electrolyte including the foregoing electrolyte may be used.

Although one example of a stacked lithium ion battery is shown in FIG. 5, the negative electrode for a lithium ion battery according to the present invention may be used in a cylindrical battery or prismatic battery having a spiral-type (wound-type) electrode group.

### EXAMPLES

### Production of Lithium Ion Battery

### Examples 1 to 2 and Comparative Example 1

### (1) Production of Negative Electrode

(a) Production of Negative Electrode Current Collector

Electrolytic plating was applied onto both surfaces of a copper foil (thickness 27 μm, HCL-02Z, available from Hitachi Cable, Ltd.), to prepare a surface-roughened copper foil. The surface-roughened copper foil had copper particles having a particle size of 1 μm on the surfaces thereof, and had a surface roughness Rz of 1.5 μm. Subsequently, the surface-roughened copper foil was passed between a pair of rollers rotating in directions opposite to each other, while pressure is applied by the pair of rollers. Ceramic rollers each having a diameter of 50 mm and a plurality of grooves formed on the surface thereof by laser machining were used as the pair of rollers. In passing the surface-roughened copper foil between the pair of rollers, the line pressure applied to the surface-roughened copper foil was adjusted to 2 kgf/cm (about 19.6 N/cm). As a result of observation under a scanning electron microscope, protrusions were formed on both front and back surfaces of the surface-roughened copper foil having passed between the pair of rollers. As shown in FIG. 2, the plain shape of the protrusion 13 was a rhombus (shorter diagonal D₁: 10 μm, longer diagonal D₂: 20 μm), and the protrusions 13 were arranged in a staggered pattern. The distance between the protrusions 13 adjacent to each other measured in the direction along the shorter diagonal D₁ was 10 μm (i.e. the center-to-center distance D₃ between the protrusions 13: 20 μm), and that measured in the direction along the longer diagonal D₂ was 18 μm (i.e. the center-to-center distance D₄ between the protrusions 13: 38 μm). The height H₁ of the protrusions 13 was about 8 μm on average. The surface-roughened copper foil with protrusions on the surfaces thereof was cut in a predetermined size, and thus the negative electrode current collector 11 was obtained.

(b) Formation of Columns

An alloy-formable active material was vapor deposited on one surface of the negative electrode current collector, to form columns of alloy-formable active material on the surfaces of the columns. A vapor deposition apparatus having the configuration as shown in FIG. 4 available from Ulvac Inc. was used for vapor deposition of the alloy-formable active material. In vapor depositing an alloy-formable active material, the position of the support table on which the negative electrode current collector 11 was placed was changed alternately between the position forming an angle α of 60° (i.e., the position indicated by the solid line in FIG. 4) and the position forming an angle (180−α) of 120° (i.e., the position indicated by the dash-dot line in FIG. 4). In this manner, columns 12 each having eight grain layers in total (12a to 12h) as shown in FIG. 3 were formed. Each of the columns 12 had grown in the direction normal to the negative electrode current collector 11 from the top surface of the protrusion 13 and the side surface of the protrusion 13 in the vicinity of the top surface.

The conditions for vapor deposition of an alloy-formable active material were as follows.

Raw material of alloy-formable active material (evaporation source): silicon, purity 99.9999%, available from Kojundo Chemical Laboratory Co., Ltd.

Oxygen released from nozzle: purity 99.7%, available from Nippon Sanso Corporation

Flow rate of oxygen released from nozzle: 80 sccm

Accelerating voltage of electron beams: −8 kV

Emission: 500 mA

Vapor deposition time: 3 min

The height H₂ of the formed columns 12 was 16 μm on average. The amount of oxygen included in the columns 12 was determined by a combustion method. The result showed that the composition of the negative electrode active material forming the columns 12 was SiO_{0.5}.

(c) Allowing Lithium to be Absorbed into Columns

Next, metallic lithium was vapor deposited onto the columns 12 being the negative electrode active material layer formed on the surface of the negative electrode current collector 11. The amount of metallic lithium to be vapor deposited was set according to the irreversible capacity of the negative electrode active material. The vapor deposition of metallic lithium was performed by using a resistance heating vapor deposition apparatus (available from ULVAC, Inc.) in an argon atmosphere. Specifically, metallic lithium was placed on the tantalum boat in the resistance heating vapor deposition apparatus, and the negative electrode current collector 11 was fixed such that the columns 12 faced the tantalum boat. Then, a current of 50 A was allowed to flow through the tantalum boat for 10 minutes to vapor deposit lithium onto the columns 12, in an argon atmosphere.

(d) Formation of Lithium Carbonate Layer

Next, the columns 12 with lithium absorbed thereinto were exposed for 72 hours to an atmosphere with a dew point temperature of −20° C. (Example 1). With respect to another negative electrode, the columns 12 with lithium absorbed thereinto were exposed for 72 hours to an atmosphere with a dew point temperature of −30° C. (Example 2). In such a manner, negative electrodes in which a lithium carbonate layer was formed on the surfaces of the columns 12 were obtained. The formation of the lithium carbonate layer on the surfaces of the columns 12 was confirmed by X-ray photoelectron spectroscopy (XPS).

### (2) Production of Positive Electrode

Cobalt sulfate was dissolved in an aqueous nickel sulfate solution, to give an aqueous solution in which the concentration of metal elements (nickel and cobalt) was 2 mol/L, and the molar ratio of nickel to cobalt was 8.5:1.5. An aqueous 2 mol/L sodium hydroxide solution was added dropwise to the resultant aqueous solution while being stirred, to form a precipitate. The resultant precipitate was collected and washed with water, and then dried at 80° C., to give a composite hydroxide represented by the formula: Ni_{0.85}CO_{0.15}(OH)₂. The resultant composite hydroxide was then heated at 900° C. for 10 hours in air, to give a composite oxide represented by the formula: Ni_{0.85}Co_{0.15}O. Subsequently, the resultant composite oxide was mixed with a lithium hydroxide monohydrate such that the total moles of nickel and cobalt were equal to the moles of lithium. The resultant mixture was heated at 800° C. for 10 hours in air, to give a lithium nickel composite oxide represented by the formula LiNi_{0.85}Co_{0.15}O₂. The resultant lithium nickel composite oxide powder (volumetric average particle size of secondary particles 10 μm) was used as the positive electrode active material.

Subsequently, 93 parts by mass of the positive electrode active material, 3 parts by mass of acetylene black and 4 parts by mass of polyvinylidene fluoride powder were dispersed in N-methyl-2-pyrrolidone. The resultant positive electrode material mixture paste was applied onto one surface of a 15-μm-thick aluminum foil, dried, and then rolled, to produce a positive electrode of 130 μm in thickness provided with a positive electrode active material layer.

### (3) Fabrication of Laminated Lithium Ion Battery

The negative electrode and positive electrode produced in the above were arranged such that the columns 12 in the negative electrode and the positive electrode active material layer in the positive electrode faced each other, and laminated together with a polyethylene microporous film (thickness 20 μm, trade name: Hipore, available from Asahi Kasei Corporation) interposed as a separator, between the negative electrode and the positive electrode, to form an electrode group. One end of a negative electrode lead made of nickel was welded to the negative electrode current collector in the electrode group thus formed; and one end of a positive electrode lead made of aluminum was welded to the positive electrode current collector. Subsequently, the electrode group was placed in a housing case made of aluminum laminate sheet, and the periphery of the housing case was welded. At this time, the periphery of the housing case was partially left open as an opening for injecting a non-aqueous electrolyte therethrough. The other ends of the negative electrode lead and positive electrode lead, that is, the ends opposite to the ends each welded to the corresponding current collector, were extended outside of the housing case.

Next, a non-aqueous electrolyte was injected into the housing case through the opening thereof. The non-aqueous electrolyte was prepared by dissolving LiPF₆ at a concentration of 1.4 mol/L in a mixed solvent containing ethylene carbonate, ethyl methyl carbonate, and diethyl carbonate in a ratio of 2:3:5 by volume. After the injection of non-aqueous electrolyte, the opening of the housing case was welded while the interior of the housing case was being evacuated to a vacuum, to hermetically seal the housing case, whereby a laminated lithium ion battery was obtained.

In Example 1, a negative electrode including the columns 12 with lithium absorbed thereinto which have been exposed for 72 hours to an atmosphere with a dew point temperature of −20° C. was used. In Example 2, a negative electrode including the columns 12 with lithium absorbed thereinto which have been exposed for 72 hours to an atmosphere with a dew point temperature of −30° C. was used. In Comparative Example 1, a negative electrode including the columns 12 with lithium absorbed thereinto which have been held in an atmosphere with a dew point temperature of below −60° C. was used.

### Evaluation of Lithium Ion Battery

(i) Battery Capacity

The lithium ion batteries of Examples 1 and 2 and Comparative Example 1 were subjected to two charge/discharge cycles under the following conditions, to measure a discharge capacity. The results are shown in Table 1.

Constant-current charging: 370 mA (1.0 C), cut-off voltage 4.15 V

Constant-voltage charging: cut-off current 18.5 mA (0.05 C), interval time 20 min

Constant-current discharging: current 74 mA (0.2 C), cut-off voltage 2 V, interval time 20 min

(ii) Mass Change Ratio of Negative Electrode

With respect to the negative electrode of each lithium ion battery, a mass M₁ immediately after lithium was absorbed into the columns 12 and a mass M₂ after a lithium carbonate layer was formed on the surfaces of the columns 12 with lithium absorbed thereinto were measured, to determined a mass change ratio of the negative electrode from the formula below.

Mass change ratio(%)=(M₂−/M₁×100

Based on that: the molecular weight of lithium carbonate is 73.9; the molecular weight of lithium included in the negative electrode is 6.94; 2 mol of lithium included in the negative electrode is converted to 1 mol of lithium carbonate; and the specific surface area of the alloy-formable active material is about 70 m²/g, it can be said that if the above mass change ratio is 1.5% or more, the lithium carbonate layer is formed in a thickness of 4 nm or more.

(iii) Charge/Discharge Cycle Performance

Each battery was subjected to constant-current charging at 370 mA (1.0 C) in a 25° C. environment until the battery voltage reached 4.15 V, followed by constant-voltage charging performed to a cut-off current of 18.5 mA (0.05 C) and then by constant-current discharging at 74 mA (0.2 C) performed until the battery voltage reached 2 V. The discharge capacity at this time was measured as an initial discharge capacity. Thereafter, the charge/discharge cycle was repeated in the same manner as above except that the current value at discharging was changed to 370 mA (1 C), and after 200 cycles, constant-current discharge was performed at 74 mA (0.2 C). The discharge capacity at this time was measured as a discharge capacity after 200 cycles. The percentage of the discharge capacity after 200 cycles to the initial discharge capacity (the cycle capacity retention rate, %) was calculated. The results are shown in Table 1.

TABLE 1

| | | Mass change ratio | Charge/discharge |
|---|---|---|---|
| | Battery capacity | of negative | cycle |
| | [mAh] | electrode | performance |
| Ex. 1 | 382 | 5% | 90% |
| Ex. 2 | 384 | 3% | 88% |
| Com. Ex. 1 | 390 | 0% | 80% |

(iv) XPS Spectrum Measurement on Columns 12

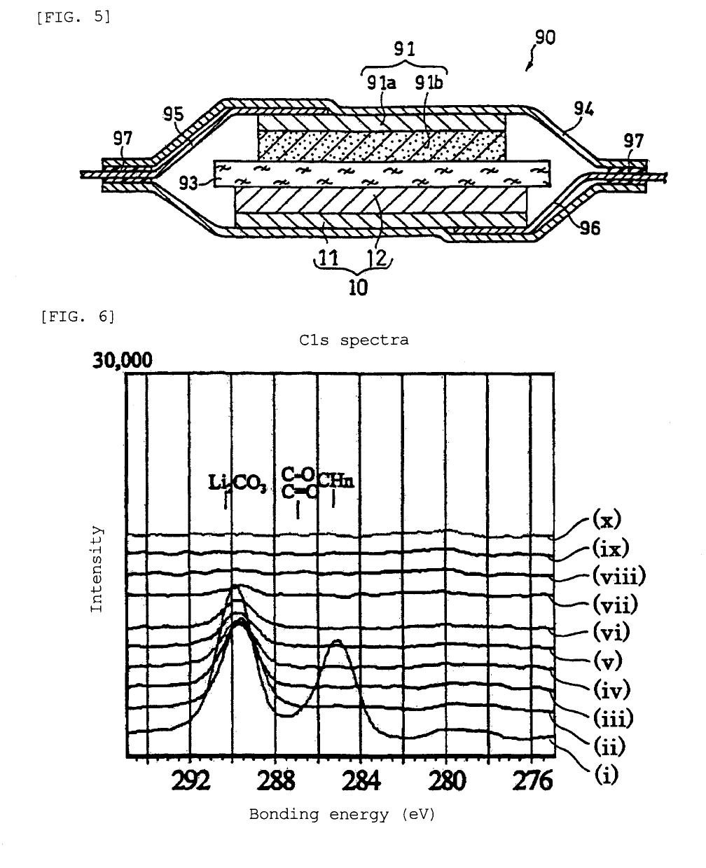

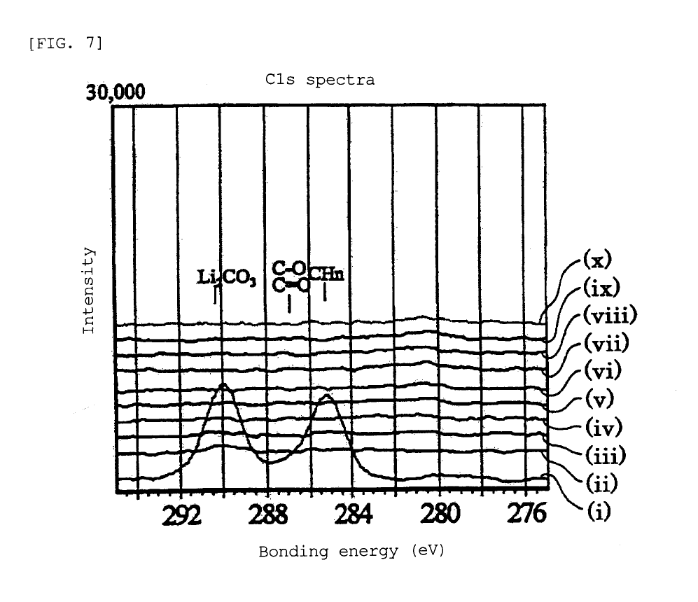

X-ray photoelectron spectroscopy spectra (C1s spectra) were measured in the following two cases where: (A) the columns 12 with lithium absorbed thereinto were stored in an atmosphere with a dew point temperature of −30° C. for 1 day; and (B) the columns 12 with lithium absorbed thereinto were stored in an atmosphere with a dew point temperature of below −60° C. for 1 day. In the XPS measurement, the columns 12 (and the coating layers 15) were etched stepwise, to trace the variation in the peak of lithium carbonate in the depth directions of the columns 12 and the coating layers 15. The XPS spectra in the case (A) are shown in FIG. 6, and the XPS spectra in the case (B) are shown in FIG. 7.

In FIGS. 6 and 7, (i) shows a spectrum measured at the outermost surfaces of the coating layers 15. (ii) to (x) show spectra measured after a stepwise etching on the columns 12 and the coating layers 15, the etching being performed to the following depths. (ii) 2 nm, (iii) 4 nm, (iv) 6 nm, (v) 8 nm, (vi) 10 nm, (vii) 20 nm, (viii) 30 nm, (ix) 50 nm, and (x) 100 nm.

As shown in Table 1, the lithium ion batteries of Examples 1 and 2, particularly the lithium ion battery of Example 1, exhibited less deterioration in charge/discharge cycle performance. This is presumably because a lithium carbonate layer is formed on the surface of the negative electrode active material layer, and therefore, even when cracks occur in the alloy-formable negative electrode active material to form newly-created surfaces, the lithium carbonate layer inhibits side reaction between the newly-created surfaces and the non-aqueous electrolyte. Comparison between Example 1 and Example 2 shows that the battery capacity and the charge/discharge cycle performance are both dependent on the thickness of the lithium carbonate layer.

Further, as evident from FIG. 6, in the case where the columns 12 with lithium absorbed thereinto were stored in an atmosphere with a dew point temperature of −30° C. for 1 day, the lithium carbonate layer was formed on the surfaces of the columns 12 in a sufficient thickness. Here, from the fact that one etching was performed by an amount corresponding to a depth of about 2 nm, the lithium carbonate layer was formed in a thickness of at least 4 nm or more.

On the other hand, as shown in FIG. 7, in the case where the columns 12 with lithium absorbed thereinto were stored in an atmosphere with a dew point temperature of below −60° C. for 1 day, the lithium carbonate layer was formed only on the surfaces of the columns 12.

### Fabrication of Lithium Ion Battery

### Example 3

### (1) Production of Negative Electrode

A negative electrode was produced in the same manner as in Example 1, except that the dew point temperature of the atmosphere to which the columns 12 with lithium absorbed thereinto were exposed was changed to −20° C., and the exposure time to the atmosphere was changed to 48 hours.

### (2) Fabrication of Battery for Evaluation

The same positive electrode and separator as used in Example 1 were used.

The negative electrode cut in the size of 15 mm square and the positive electrode cut in the size of 14.5 mm square were arranged such that the columns 12 in the negative electrode and the positive electrode active material layer in the positive electrode faced each other, and were laminated together with the separator interposed between the negative electrode and the positive electrode, to form an electrode group. One end of a negative electrode lead made of nickel was welded to the negative electrode current collector in the electrode group thus formed; and one end of a positive electrode lead made of aluminum was welded to the positive electrode current collector. Subsequently, a battery (a laminated lithium ion battery) for evaluation was fabricated in the same manner as in Example 1, except that the electrode group thus formed was used. For the non-aqueous electrolyte, a non-aqueous electrolyte having the same composition as that used in Example 1 was used.

### Example 4

A negative electrode was produced in the same manner as in Example 1, except that the dew point temperature of the atmosphere to which the columns 12 with lithium absorbed thereinto were exposed was changed to −50° C., and the exposure time to the atmosphere was changed to 48 hours. A battery for evaluation was fabricated in the same manner as in Example 3, except that the negative electrode thus produced was used.

### Comparative Example 2

A battery for evaluation was fabricated in the same manner as in Example 3, except that the negative electrode including the columns 12 with lithium absorbed thereinto which have been held in the atmosphere with a dew point temperature of below −60° C. was used.

### Example 5

A non-aqueous electrolyte was prepared by dissolving LiPF₆ at a concentration of 1.4 mol/L in a mixed solvent containing ethylene carbonate, ethyl methyl carbonate, and diethyl carbonate in a ratio of 2:3:5 by volume, and then dissolving fluoroethylene carbonate at a ratio of 2% by mass relative to the total mass of the mixed solvent including LiPF₆. A battery for evaluation was fabricated in the same manner as in Example 3, except that the non-aqueous electrolyte thus prepared was used.

### Example 6

A battery for evaluation was fabricated in the same manner as in Example 4, except that the same non-aqueous electrolyte as prepared in Example 5 was used.

### Comparative Example 3

A battery for evaluation was fabricated in the same manner as in Example 5, except that the negative electrode including the columns 12 with lithium absorbed thereinto which have been held in the atmosphere with a dew point temperature of below −60° C. was used.

### Comparative Example 4

The alloy-formable active material was vapor deposited on the surface of the surface-roughened copper foil (the negative electrode current collector) having protrusions on the surface thereof, in the same manner as in Example 1, to form a plurality of columns of alloy-formable active material. A coating layer of lithium carbonate was formed by sputtering on the columns thus formed, under the conditions below. The thickness of the coating layer on the top surface of the column was about 6 nm.

Flow rate of Ar from nozzle: 50 sccm

Pressure of gas: 10⁻¹ Pa

HF frequency: 13.56 MHz

Power: 200 W

Sputtering time: 7 min

Subsequently, a battery for evaluation was fabricated in the same manner as in Example 3, except that the negative electrode thus produced was used.

### Comparative Example 5

The alloy-formable active material was vapor deposited on the surface of the surface-roughened copper foil (the negative electrode current collector) having protrusions on the surface thereof, in the same manner as in Example 1, to form a plurality of columns of alloy-formable active material. Further, lithium was vapor deposited on the columns thus formed, in the same manner as in Example 1. After the vapor deposition of lithium, the interior of the resistance heating vapor deposition apparatus was evacuated to a vacuum, and then an inert gas containing carbon dioxide and argon mixed in a ratio of 20:80 by volume was introduced into the apparatus, to adjust the atmospheric pressure in the apparatus to be a normal pressure. Thereafter, the columns into which lithium had been absorbed beforehand were stored for 0.25 hours in the apparatus. The thickness of the coating layer was about 1 nm. Subsequently, a battery for evaluation was fabricated in the same manner as in Example 3, except that the negative electrode thus produced was used.

### Evaluation of Battery

(i) Battery Capacity

Batteries for evaluation of Examples 3 to 6 and Comparative Examples 2 to 5 were subjected to two charge/discharge cycles under the following conditions, to measure a discharge capacity. The results are shown in Table 2.

Constant-current charging: 5.25 mA (0.7 C), cut-off voltage 4.15 V

Constant-voltage charging: cut-off current 0.375 mA (0.05 C), interval time 20 min

Constant-current discharging: current 7.5 mA (1 C), discharge cut-off voltage 2.5 V, interval time 20 min

(ii) Charge/Discharge Cycle Performance

Each battery was subjected to constant-current charging at 5.25 mA (0.7 C) in a 25° C. environment until the battery voltage reached 4.15 V, followed by constant-voltage charging performed to a cut-off current of 0.375 mA (0.05 C) and then by constant-current discharging at 7.5 mA (1 C) performed until the battery voltage reached 2.5 V. The discharge capacity at this time was measured as an initial discharge capacity. Thereafter, the charge/discharge cycle was repeated at the discharge current of 7.5 mA (1 C), to count the number of cycles repeated until the capacity retention rate reduced to 80% relative to the initial discharge capacity. The results are shown in Table 2.

TABLE 2

| | | Charge/discharge |
|---|---|---|
| | Battery capacity | cycle performance |
| | [mAh] | (number of cycles) |
| Ex. 3 | 6.65 | 244 |
| Ex. 4 | 6.70 | 218 |
| Com. Ex. 2 | 6.72 | 205 |
| Ex. 5 | 6.63 | 300 |
| Ex. 6 | 6.65 | 280 |
| Com. Ex. 3 | 6.70 | 232 |
| Com. Ex. 4 | 6.60 | 200 |
| Com. Ex. 5 | 6.70 | 204 |

As shown in Table 2, Examples 3 and 4 exhibited improved charge/discharge cycle performance as compared to Comparative Example 2; and Examples 5 and 6 exhibited improved charge/discharge cycle performance as compared to Comparative Example 3. This is presumably because a lithium fluoride layer is evenly formed on the surfaces of the columns as a result of forming a lithium carbonate layer on the surface of the negative electrode active material layer and then fabricating a battery using a non-aqueous electrolyte containing fluorine element, and therefore, even when cracks occur in the alloy-formable negative electrode active material to form newly-created surfaces, the lithium fluoride layer inhibits side reaction between the newly-created surfaces and the non-aqueous electrolyte.

As is clear from comparison between Examples 3 and 4 and Examples 5 and 6, the charge/discharge cycle performance was improved as a result of adding a non-aqueous solvent of a fluorine-containing compound (fluoroethylene carbonate) in the non-aqueous electrolyte. The reason for such further improvement of the charge/discharge cycle performance is presumably in that fluoroethylene carbonate is more excellent in forming a lithium fluoride layer than a solute of a fluorine-containing compound (LiPF₆).

As is clear from comparison with Example 3, in Comparative Example 4, presumably, the reaction with the non-aqueous electrolyte was not inhibited because the lithium carbonate coating layer was formed on the top surfaces of the columns but not sufficiently formed on the side surfaces. Further, in Comparative Example 5, presumably, the reaction with the non-aqueous electrolyte was not inhibited because of an insufficient formation of the lithium carbonate coating layer to be as small as about 1 nm.

The above description is presented as illustrative embodiments of the invention, but this is merely illustrative and should not be taken as limiting the scope of the invention. Variant examples of the invention which will be apparent to those skilled in the art are encompassed by the claims of the invention.

### INDUSTRIAL APPLICABILITY

The negative electrode for a lithium ion battery and a lithium ion battery using the same of the present invention are useful, for example, as a power source for portable electronic equipment.

1. A negative electrode for a lithium ion battery comprising
a negative electrode current collector,
a plurality of columns formed so as to be spaced apart from each other on a surface of the negative electrode current collector, and
a coating layer coating an entire surface of each of the plurality of columns, wherein:
the columns include a negative electrode active material comprising either one of silicon and tin, and further include lithium absorbed thereinto; and
the coating layer contains at least one of lithium carbonate and lithium fluoride.

2. The negative electrode for a lithium ion battery in accordance with claim 1, wherein the coating layer has a thickness of 4 nm or more on the entire surface of the column.

3. The negative electrode for a lithium ion battery in accordance with claim 1, wherein a difference between a thickness of the coating layer at a top surface of the column and a thickness of the coating layer at a side surface of the column is 3 nm or less.

4. The negative electrode for a lithium ion battery in accordance with claim 1, wherein the lithium carbonate is formed by exposing the columns to an atmosphere with a dew point temperature of −60° C. or higher and 0° C. or lower.

5. The negative electrode for a lithium ion battery in accordance with claim 1, wherein the lithium fluoride is formed by allowing the columns with a coating layer containing lithium carbonate formed thereon to contact with a non-aqueous electrolyte containing at least one of a solute including a fluorine-containing compound and a non-aqueous solvent including a fluorine-containing compound.

6. The negative electrode for a lithium ion battery in accordance with claim 1, wherein the negative electrode current collector has a plurality of protrusions formed so as to be spaced apart from each other on the surface thereof, and the protrusions support the columns one by one.

7. The negative electrode for a lithium ion battery in accordance with claim 6, wherein the protrusions are arranged in a regular pattern on the surface of the negative electrode current collector.

8. The negative electrode for a lithium ion battery in accordance with claim 1, wherein each of the columns is a stack of a plurality of grain layers containing either one of silicon and tin.

9. The negative electrode for a lithium ion battery in accordance with claim 1, wherein the negative electrode current collector comprises either copper or a copper alloy.

10. A method for producing a negative electrode for a lithium ion battery, the method comprising the steps of:
forming a plurality of columns so as to be spaced apart from each other on a surface of a negative electrode current collector, the columns including a negative electrode active material comprising either one of silicon and tin;
allowing lithium to be absorbed into the plurality of columns; and
allowing the columns with lithium absorbed thereinto to be exposed to an atmosphere with a dew point temperature of −60° C. or higher and 0° C. or lower, thereby to form a coating layer containing lithium carbonate on surfaces of the columns.

11. The method for producing a negative electrode for a lithium ion battery in accordance with claim 10, wherein an exposure time to the atmosphere is 0.5 to 148 hours.

12. The method for producing a negative electrode for a lithium ion battery in accordance with claim 10, wherein the dew point temperature is −40° C. or higher and −20° C. or lower.

13. The method for producing a negative electrode for a lithium ion battery in accordance with claim 12, wherein the exposure time to the atmosphere is 48 to 72 hours.

14. The method for producing a negative electrode for a lithium ion battery in accordance with claim 10, further comprising the step of allowing the columns with a coating layer containing lithium carbonate formed thereon to contact with a non-aqueous electrolyte containing at least one of a solute including a fluorine-containing compound and a non-aqueous solvent including a fluorine-containing compound, thereby to form lithium fluoride in the coating layer.

15. The method for producing a negative electrode for a lithium ion battery in accordance with claim 14, wherein the solute is LiPF₆.

16. The method for producing a negative electrode for a lithium ion battery in accordance with claim 14, wherein the non-aqueous solvent is at least one of fluoroethylene carbonate and difluoroethylene carbonate.

17. A lithium ion battery comprising:
a negative electrode including a negative electrode current collector, a plurality of columns formed so as to be spaced apart from each other on a surface of the negative electrode current collector, and a coating layer coating a surface of each of the plurality of columns;
a positive electrode including a positive electrode active material capable of absorbing and desorbing lithium;
a separator insulating the negative electrode and the positive electrode from each other; and
a non-aqueous electrolyte; wherein:
the columns include a negative electrode active material comprising either one of silicon and tin, and further include lithium absorbed thereinto; and
the coating layer contains at least one of lithium carbonate and lithium fluoride.

18. The lithium ion battery in accordance with claim 17, wherein the non-aqueous electrolyte containing at least one of a solute including a fluorine-containing compound and a non-aqueous solvent including a fluorine-containing compound.
